(19) United States
(12) Patent Application Publication
(10) Pub. No.: US 2024/0326168 A1
(43) Pub. Date: Oct. 3, 2024

(54) Method for welding or additive manufacturing by laser fusion then cooling with powder inerting

(71) Applicant: COMMISSARIAT A L’ENERGIE ATOMIQUE ET AUX ENERGIES ALTERNATIVES, PARIS (FR)

(72) Inventors: Lucas BRIZZI, GOMETZ-LE-CHATEL (FR); Gilles FONDANT, VAUVILLE (FR)

(21) Appl. No.: 18/618,301

(22) Filed: Mar. 27, 2024

(30) Foreign Application Priority Data
Mar. 31, 2023 (FR) 2303162

(51) Int. Cl. B23K 26/24; B23K 26/12; B23K 103/04

(52) U.S. Cl. CPC B23K 26/24; B23K 26/123; B23K 2103/04

(57) ABSTRACT

A method for forming metallic material by fusion then cooling, includes an application of laser radiation on the material to be treated, and a progressive displacement of the radiation over a path of treatment of the material to be treated. The material to be treated is coated with an inerting powder, the inerting powder being removed downstream of the application of the radiation after cooling of the melt pool.

### CROSS-REFERENCE TO RELATED APPLICATION

This application claims priority to foreign French patent application No. FR 2303162, filed on Mar. 31, 2023, the disclosure of which is incorporated by reference in its entirety.

### FIELD OF THE INVENTION

The invention falls within the field of the forming of metal parts for industry. The industries concerned are varied: aeronautics and space, the military field, building and public works sites, the naval industry, and the nuclear industry, in particular. The forming of the metal parts envisaged can be a welding of two metal parts of the same composition or of different compositions, with or without filler material, or additive manufacturing using an addition of metal on a metallic base that is already present. These metallic material forming methods can notably be used for the first shaping of a single part or of parts manufactured in small numbers, or for the repairing of parts that are very costly and complex to produce, for, for example, areas of wear of a portion of the part or for repairs of cracks that have appeared over the life of the part. Different welding and additive manufacturing techniques are known, notably the focused welding techniques that use laser radiation, in which laser radiation is displaced (relative to the parts) at the interface of the two parts to be welded, creating a melt pool slightly upstream of the point of impact and downstream of the impact, which solidifies to form the weld, in which the materials of the two parts have coalesced.

### BACKGROUND

The technical requirements demand very high weld qualities, particularly in the nuclear field. The imperfections or defects are largely eliminated by a rigorous cleaning of the parts prior to welding. However, it is very important also to add a gaseous protection by inerting with a neutral gas which is generally argon or nitrogen, and which protects the melt pool from oxidation by contact with the air, the latter containing oxygen and moisture that the melt pool should be protected from. The neutral gas is sprayed by a nozzle surrounding the laser toward the melt pool in order to have the moisture and oxygen content locally decreased. The main drawback with gas is that it dilutes rapidly in the ambient air, a phenomenon which is amplified by the strong temperature gradients created by the laser heat source.

The high power densities and the high speeds employed for the laser welding methods thus reduce the effectiveness of the gaseous protection of the melt pool. Inerting boxes or chambers or, more broadly, inerting systems, whether rigid or flexible, make it possible to contain the protection gas to increase its effectiveness. They thus ensure a good protection of the melt pool but must be matched to the geometry of each part to be welded which makes them very, even excessively, restrictive to implement in many configurations because of the complexity of the geometries of the welds to be produced. The inerting chamber systems are complex and they must be created on a per-case basis. In particular, the inerting box must be interfaced with the laser welding head and the two parts to be welded, which is complex to implement.

Laser welding and laser-wire additive manufacturing for parts of large dimensions in an ambient medium ultimately remain industrially impractical, and there are few well-known methods although there is a growing demand to obtain greater welding speeds. Thus, the state of the art offers few solutions for the following difficulties: ensuring a protection of the melt pool on complex mechanical assemblies where the inerting chambers or boxes cannot be installed, simplifying the laser beam welding and laser-wire additive manufacturing procedures, reducing the costs associated with the laser welding, and with the laser-wire additive manufacturing in the configurations specific to the parts of the nuclear industry, reducing the preparation and intervention times on welding zones in an ambient media such as open-air work sites or factories, allowing laser welding, and laser-wire additive manufacturing on parts of large dimensions at high speeds without any inerting chamber or box, increasing by 10 to 20% the laser welding performance levels and the quality of the melt pool, and allowing inerting on robotized systems with 5 or 6 axes in an inerting chamber or box.

One difficulty with laser methods (with or without filler material) in an ambient medium is, as has been stated, the gaseous protection of the melt pool, because it conditions the final quality of the welded assemblies. Such welding operations in an ambient medium, that is to say without inerting box or chamber, are envisaged in particular for the naval industry or building and public works work sites, and they can be performed in an inerting box or chamber as an additional precaution for the industries that are even more demanding such as nuclear, aeronautics and aerospace.

The electric arc welding methods, notably the TIG/MIG (Tungsten Inert Gas and Metal Inert Gaz) and coated electrode methods are widely used in the industry. Currently, the welds that are complex or difficult to access are produced by welding methods other than laser welding. Electric arc welding uses a tungsten electrode—TIG welding—or a fusible electrode wire. When the electrode is not fusible, which is the case with TIG welding, a filler wire or filler stick can be used to add metal to the parts being worked. If the electrode is fusible, which can be the case with MIG welding, it can be advanced progressively to provide such an addition of metallic material. In the context of these arc welding methods, the possibility of working with the arc submerged, namely the electric arc under a flux of inerting powder, is known. This is a very specific method, limited to the creation of an electric arc between an electrode wire to which is applied a potential opposite to another potential applied to the parts to be welded, which are brought closer until contact with the end of the electrode wire under the powder flux.

However, the TIG, MIG and coated electrode welding methods remain slow, and replacing them with laser welding (with or without filler material) not requiring inerting boxes would, in certain fields, make it possible to reduce the welding times, including the currently laborious placement of the equipment necessary to the inerting, and the costs.

### SUMMARY OF THE INVENTION

The invention consists in implementing a method for forming metallic material by fusion then cooling, comprising an application of laser radiation on the material to be treated, and a progressive displacement (relative to the material to be treated) of said radiation over a path of treatment of the material to be treated.

This method is particular in that upstream or in line with the point of impact of the radiation, the material to be treated is coated with an inerting powder, the inerting powder being removed downstream of the application of the radiation after cooling of the melt pool, the laser beam being projected through the powder and focused on the material to be treated, on its surface or possibly slightly below.

Through these principles, which consist in having the unfocused laser ray pass through a thickness of inerting powder, of having performed the focusing at the bottom of the layer of powder, and of waiting for the melt pool to cool to remove the powder, the existing welding techniques are greatly improved and there is a saving in productivity compared to the methods that do not use laser, or to methods requiring specific inerting chambers to be built.

Optionally and advantageously,
the laser radiation can be applied and displaced jointly with a wire whose end is placed under the laser radiation so as to constitute a filler material at the point of impact of the laser on the metallic base of the material to be treated, the base being able to be unique or composed of two parts to be welded, to which it is applied
the filler material can be dimensioned for additive manufacturing implemented on such a metallic base receiving the laser radiation
the laser radiation can be applied and displaced at the join between two metallic parts to be welded, included in or constituting the material to be treated, affixed beforehand with surface to be welded against surface to be welded
the two metallic parts can be of the same composition, or of different compositions (same alloy, or different alloys)
the metallic parts and, more broadly, the material to be treated, can be made of steel or comprise a steel
the method can be implemented with or without inerting box containing an inerting gas (argon, nitrogen, helium for example) to protect the melt pool, in addition to the inerting powder
the powder can be composed of a mixture of 35% SiO₂+Al₂O₃ and 65% CaF₂+CaO+MgO for the laser beam welding of two stainless steel X10CrMoVNb9.1 plates, but that is just one example among others, the powder being, moreover, matched to the nature of the material or of the alloy the laser beam can be delivered by an Nd-YAG source, but other sources exist and can be used
the powder can be deposited in the form of a smoothed flux.

The advantage of this invention, in terms of welding, falls into two categories for identical technical and mechanical results: for a given welding thickness, the invention makes it possible to decrease the necessary laser power, and decrease the welding fumes, which are noxious for the environment, and, for a given laser power, the invention makes it possible to considerably increase the thicknesses of parts that can be welded.

For laser-wire additive manufacturing, the invention makes it possible to decrease the laser power in order to lower the temperature of the part and thus make the temperature gradients uniform over all of the part.

### BRIEF DESCRIPTION OF THE DRAWINGS

FIG. 1 is a general representation in transverse cross-section of a laser welding operation in an inerting box.

FIGS. 2A and 2B are representations in longitudinal and transverse cross-section of a welding operation according to the invention.

FIG. 3 is a representation in longitudinal cross-section of a laser-wire additive manufacturing operation according to the invention.

### DETAILED DESCRIPTION

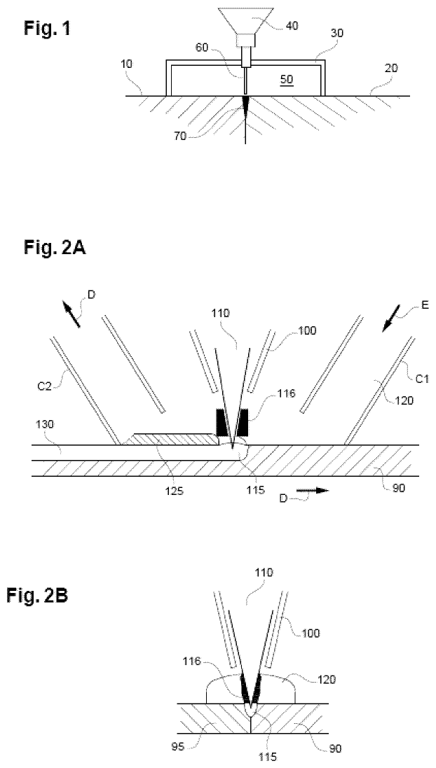

FIG. 1 shows, according to known principles, two metal parts 10 and 20 in cross-section, placed side-by-side, lateral faces that have to be welded being affixed against one another. An inerting box 30 is placed above the join between the two metal parts 10 and 20, and a gas injection system is linked thereto, so as to create a regulated atmosphere. The laser source 40 is interfaced with the inerting box 30 such that it is directly above the join between the two metal parts 10 and 20. The gas 50 is injected into the internal volume of the inerting box and the laser beam 60 is directed to the join, which starts to melt and forms a weld 70. The transient melt pool is protected from oxidation and from moisture by the gas 50, typically argon or nitrogen. The laser beam is displaced transversely to the plane of the figure, along the join interface between the parts 10 and 20. The displacement of the laser is relative to the parts: it may be the parts which are displaced with respect to the laser rather than the reverse, naturally.

In FIG. 2A, an embodiment of the invention has been represented. The figure is, on the left, a cross-section with, this time, the direction of displacement D of the laser parallel to the cross-section plane. Again, the displacement of the laser is relative to the parts: it can be the parts which are displaced with respect to the laser rather than the reverse, naturally.

In FIG. 2B, a transverse cross-section of the same method, with the same position of the elements, is presented, so as to visualize both the laser beam and the two parts to be welded.

A single metal part 90 is visible in FIG. 2A, because the cross-section is produced in the joining plane of the two parts, these being placed in contact with one another by two flat faces, typically abutment edges. The second part, referenced 95, is visible in FIG. 2B.

It is possible to abut the parts to be welded by surfaces that are not flat, but nevertheless complementary to one another. The upper part of the abutment surfaces is the path of advance of the laser beam for the purposes of the weld, that is to say the treatment of the material to be formed. This path is often rectilinear, but it can be curvilinear if the abutment surfaces are not flat.

Above the parts, in the joining plane, the laser source whose nozzle 100 can be seen is placed, and, through the nozzle 100, the laser beam 110 appears, focused on the surface of the metal parts (or slightly below) and provokes the formation of the melt pool 115 in the metal, at the join of the two parts. However, before reaching the metal parts, it is projected through a granular powder, over a trajectory of, for example, 5 to 8 mm in the powder layer, along which it is focused.

According to the invention, a powder 120 deposited dynamically upstream of the impact of the laser has in fact been placed on the join of metal parts to be welded through a deposition duct C1, constituting an input E of powder sprayed onto the metal parts, which accumulates to form a layer which can be 5 to 8 mm thick depending on the nature of the materials used. The powder deposition, performed by the deposition duct C1, is smoothed by the latter, on the surface, which is essentially flat in the zone of application of the laser and has been deposited horizontally, of the parts 90 and 95, which allows formation of a uniform powder layer. The powder, as soon as it is present on the metal, is ready to ensure its protection against the gases of the atmosphere, in particular the water and dioxygen. Its thickness is matched to the speed of displacement D: if the displacement is slow, a greater thickness of powder is necessary, possibly until the bottom of the nozzle 100 is embedded in the powder 120.

Thus, the focusing of the laser 110 takes place at the bottom of the powder layer deposited a few instants earlier and which coats the join of the two metal parts at the point where the laser is progressively displaced. The powder, impacted by the laser in its unfocused portion, starts to melt also, and the metal starts to melt under a thickness of molten powder. Above the metal melt pool 115, molten powder, or even sublimated powder, 116 is thus present.

With the displacement continuing, the materials cool downstream of the current impact of the laser, the molten powder solidifies into a slag 125, and the molten metal solidifies into the weld or weld bead 130.

A suction duct C2, downstream of the impact of the laser, removes, by a negative pressure effect D, the powder and at least a part of the slag.

In one embodiment, the powder is composed of a mixture of 35% SiO₂+Al₂O₃ and 65% CaF₂+CaO+MgO for the laser beam welding of two stainless steel X10CrMoVNb9.1 (a steel that is difficult to weld, applicable to the nuclear industry) plates 11 mm thick, each with a laser beam with a continuous power of 8 KW delivered by an Nd-YAG source.

The powder is applied in the form of a smoothed flux and can comprise an acidic or basic mixture depending on the basicity indices routinely used.

Two types of inerting were compared: by argon spraying and by powder flux. For a penetration of the melt pool in the depth of the parts to be welded that is identical, it is possible to reduce the power of the laser beam from 8 kW two 6.3 KW with equal displacement speed. This reduction of firing power of the laser beam by more than 20% is considerable. The metallographic analyses performed on these welds make it possible to confirm a high quality and purity of the melt pool after solidification. There is no defect in the weld.

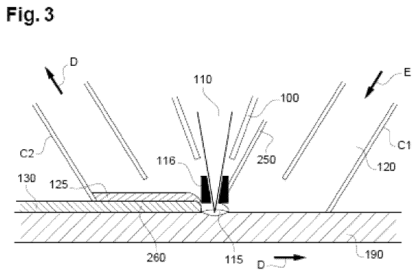

FIG. 3 shows an implementation of the process for welding with filler or laser-wire additive manufacturing. The figure is like FIG. 2A in cross-section with the direction of displacement D of the laser parallel to the cutting plane.

A single metal part 190 can be present this time, and the cut is then produced in a plane in which an addition of the material will be made—the plane of the path of the laser, bearing in mind that this path can be curved, in which case the plane is chosen locally-on the surface of the metal part 190. However, the representation of FIG. 3 is also compatible with the presence of two metal parts as in FIGS. 2A and 2B, and the formation of a weld with filler material.

Also within the scope of the present disclosure lies the possibility of simultaneously combining welding and additive manufacturing.

A filler wire 250 is placed at the location targeted by the laser source. Above the part, in the deposition plane (the plane of the figure), the laser source, which provokes the formation of the melt pool 115 in the filler metal and on the surface of the metal part 190 (and of the second metal part if appropriate), is placed on the path of the addition of material to be performed.

According to the invention, a powder flux 120, deposited dynamically upstream of the impact of the laser on the path of the material to be deposited, has, in addition, been put in place by the deposition duct C1. The deposition, performed by the deposition duct C1, is smoothed by the latter (the surface on which the powder is deposited is flat in the zone to which the laser is applied, which allows construction of the smoothed powder layer). The powder, as soon it is present on the metal, ensures its protection against the gases of the atmosphere, in particular the water and the dioxygen.

The powder, impacted by the laser beam before the focusing thereof, starts to melt, and the metal of the wire starts to melt under the effect of the laser beam which touches it at its focal point or in great proximity thereto, under a thickness of molten or sublimated powder. The metal of the surface, at least of the metal part 190 (and of the second metal part if appropriate) also starts to melt, since it is touched by the laser at its focal point on the surface of the metal or slightly below.

With the displacement continuing, the powder solidifies partially into a slag 125, and the molten metal solidifies into the welded and/or additively added material, forming a weld bead 260 and/or an added relief 260 above the surface of the metal part 190. As in FIG. 2A, a suction duct C2, downstream of the impact of the laser, removes the powder and at least a part of the slag.

Once the forming of the parts has been finished by the processes mentioned above and their temperature has reverted to ambient temperature, their surfaces can be cleaned electrochemically.

The quality of the assemblies and parts formed is highly satisfactory, with methods that have increased performance levels.

The method applies to all metals and metallic alloys, including for example zirconium or the reduced-activation/ferritic/martensitic (RAFM) steels.

Instead of a pay-out device C1 upstream of the laser source, the powder can be deposited by a nozzle surrounding the laser source and constituting a powder pay-out device, in line with, or plumb with, the impact of the laser on the metallic material to be treated.

Ultimately, the invention consists, in the context of the application of a laser, in cleaning the melt pool under an inerting powder flux, the composition of which is matched to the metals or alloys to be welded in the context of a weld or to be handled in the context of additive manufacturing. This solution is suited to the laser welding with or without filler material and to laser additive manufacturing.

It can optionally be implemented in an inerting chamber, under an inerting gas, to even further guarantee the quality of the weld or of the additive manufacturing performed, for example for the most material-intensive industries, like the nuclear field.

It makes it possible to save time compared to the known techniques, and/or enhance the quality obtained.

1. A method for welding two metal parts by fusion then cooling, comprising an application of laser radiation, and a progressive displacement (D) of said laser radiation at the join between the two parts to be welded, wherein the material to be treated is coated with an inerting powder, the inerting powder being removed downstream of the application of the radiation after cooling of a melt pool produced by said application of the radiation, the laser beam being projected through the powder and focused on the material to be treated, the parts being affixed previously with surface to be welded against surface to be welded, the surfaces complementing one another.

2. The method for forming metallic material according to claim 1, wherein the two metal parts are of the same composition.

3. The method for forming metallic material according to claim 1, wherein the material to be treated comprises a steel.

4. The method for forming metallic material according to claim 1, being implemented with or without an inerting box containing an inerting gas to protect the melt pool.

5. The method for forming metallic material according to claim 1, wherein the laser beam is delivered by an Nd-YAG source.

6. The method for forming metallic material according to claim 1, wherein the powder is deposited in the form of a smoothed flux.
